(19) United States
(12) Patent Application Publication
(10) Pub. No.: US 2012/0167891 A1
(43) Pub. Date: Jul. 5, 2012

(54) ADJUSTABLE FACIAL CONFORMING FACE MASK

(76) Inventor: John Smaller, Poway, CA (US)

(21) Appl. No.: 12/983,839

(22) Filed: Jan. 3, 2011

(51) Int. Cl. A62B 7/10; A62B 18/02

(52) U.S. Cl. 128/206.19; 128/206.28

(57) ABSTRACT

An adjustable face mask having a body conforming substantially to the facial structure of a wearer. The face mask is provided with a neck shield and removable filter and novel air apertures providing a communication of forced air to the nose and mouth of a user. The face mask can optionally provide neck protection with a descending neck member.

### BACKGROUND OF THE INVENTION

1. Field of the Invention

The current invention relates generally to face masks and face coverings. More specifically it relates to face masks that provide continuous air filtration, face and neck protection and warmth particularly while the wearer is moving such as riding on a motorcycle, skiing, and participating in a powersport.

2. Prior Art

It has become ever more popular in recent years for both young people and older people to ride motorcycles. The increase in riders is both by necessity for those finding motorcycles economical to operate, and, for pleaser for those riders revisiting their youth or who just enjoy a motorcycle ride.

However, such riding of motorcycles, on the highways and off the road, introduces the hazard of flying debris such as stones, gravel, sand, and more particularly in many areas of the country, insects. In states requiring helmets and for riders who choose to wear them, there are some helmets which incorporate face guards for protection from large objects, however they also tend to cover the entire face and do little or nothing for air filtration needed in dusty or sandy environments.

Conversely, open-faced helmets provide no face protection whatsoever to the rider which can result in some serious impacts with the rider's face by bugs and road debris. However an open faced helmet is preferred by many motorcycle riders, because of style, and because unlike the helmets with shields, open faced helmets do not fog and impair rider vision.

Other sports such as skiing, mountain biking, snowboarding, snowmobiling, and the like, are becoming ever more popular with both youthful riders as well as aging riders. Some riders wear helmets for such, and some do not, but all are moving at medium to high speeds and thus encountering wind on their faces and issues related to such as wind chill, and impacts with dirt, dust, and bugs.

For skiers, and bike riders and motorcycle riders and other powersport participants wearing helmets, choosing open faced helmets or no helmets, other devices are employed to protect their face, such as full face shields and goggles. However while these devices afford some protection to the face of such riders, they can be prone to fogging of the transparent lens which often occurs due to the heavy breathing of the user, and/or temperature differentials between the interior of such shields and the atmosphere. Further, most such shields afford no form of air filtration to protect the breathing and eyes of the rider in areas prone to dust, smoke, or pollution.

Face mask and face protection devices that provide face coverage as well as air filtration do so by including an insert on the inner surface of the mask for installation and removal of standard dust masks not provided with the device initially. This of course requires the user to purchase extraneous products to achieve the desired face protection and air filtration offered by the mask. Similarly, the comfort level experienced by the user will be determined by the type of dust masked used, which may vary from brand to brand as well as provide no means to prevent fogging of goggle lenses or face shield if worn simultaneously with the face mask due to heavy breathing of the user. Also, other current face masks provide a user with air filtration while failing to provide adequate face protection from hazards such as flying debris.

As such, it is seen that there is a need for a face mask that provides a balance of protection, warmth, and air filtration. Such a device should be wearable by many types of riders and sports participants to protect their faces from both weather and from impacts which occur at medium to high speeds with bugs and debris and the like.

### SUMMARY OF THE INVENTION

The present invention herein provides face and neck protection by means of semi-soft malleable material which provides a facial-conforming means, such as neoprene, and having an interior surface adapted to be gentle to the user's skin and having an exterior surface configured to the elements. The material has a thickness and density to afford insulation from wind chill as well as to form a pad against potential impacts from road debris and such other airborne hazards as insects.

The interior surface is fitted directly against the users face in the as-used position and using the preferred material and its elastic nature, will generally conform to the surface of the face. In a particularly preferred mode, there is a replaceable filter engaged between the interior surface of the mask in the area of the nose and mouth of the user. In the preferred mode of the device, the filter is formed of a bamboo/carbon-fiber material as this is naturally hypoallergenic and will not cause irritation to the skin of the user.

A means to securely engage the device to the user in a preferred mode, is provided using hook and loop type fastener material, or other fasteners which are positioned on straps. The straps have a length sufficient to extend around the neck to the back of the user's head with appreciable overlap to allow for secure engagement into the head in the as-used position.

To assist the user in breathing through the device there is provided, an array of apertures positioned inline with and proximate to the nose/mouth area of the user and the device. The quantity, orientation, and diameter of the apertures are of such construction to yield an aggregate area of air passage to supply the user with sufficient air supply for breathing. In a preferred mode of the device, the apertures are formed in a frusto conical shape, with the wider end of the cone facing away from the face of the rider. This positions the apertures to each act as air rams to provide a means to communicate air from the exterior surface to the interior surface and through the filter before reaching the users respiratory system under a force to both aid air filtration through the filter and breathing. Thus the apertures in this conical shape, with smallest cross sectional area at the interior surface, provides a means to increase airflow to the user caused by the provided increase air velocity must increase as cross sectional area decreases.

In one embodiment, the vertical extent of the device begins at the bridge of the nose and continues to just below the chin. This embodiment encompasses full coverage of the nose, mouth, and cheeks with the securement strap extending around the neck.

In another embodiment, the device extends from the bridge of the nose to just below the shoulder line of the wearer, offering full frontal neck coverage as well.

In all embodiments, there is a thin semi-rigid malleable strip of material extending around the bridge area of the nose at the upper most section of the device. This allows the user to adjust the fit of the device at the nose, namely create a more snug fit about the nose as to not allow air to escape as is the common fault for fogging of goggles that occurs due to heavy breathing. This part of the device is similar to that of medical nose/face masks seen commonly in use today.

With respect to the above description, it is to be understood that the invention is not limited in its application to the details of operation of the invention nor the arrangement of the components or steps in the method set forth above or in the following descriptions or in the illustrations in the drawings. The various methods of implementation and operation of the disclosed device herein, are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Those skilled in the art will appreciate that the conception upon which this disclosure is based may readily be utilized as a basis for designing similar face shielding devices adapted to conform to the user's facial structure and for carrying out the several purposes of the present invention. Therefor, the objects and claims herein should be regarded as including such equivalent constructions, steps, and methodology insofar as they do not depart from the spirit and scope of the present invention.

It is an object of the present invention to provide a user with protection and warmth of the nose/mouth region of the face as well as for the neck when exposed to cold or wind.

It is another object of the invention to provide a means to filter incoming air via a removable filter.

It is yet another object of the invention to provide a means for increased active air flow through the device to the user.

It is still another object of the invention to maintain a close and secure engagement about the bridge of the nose.

These together with other objects and advantages which will become subsequently apparent reside in the details of the adjustable facial conforming facemask as more fully hereinafter described and claimed, reference being had to the accompanying drawings forming a part thereof.

### BRIEF DESCRIPTION OF THE FIGURES

FIG. 1 depicts one embodiment of the device providing neck protection to a user showing straps, air intake apertures, and filter snap locks.

FIG. 2 shows the interior surface of the invention depicted in FIG. 1.

FIG. 3 depicts another embodiment of the device providing face protection only, also showing straps, air apertures, and filter engagement snap fits.

FIG. 4 shows the interior surface of the invention as depicted in FIG. 3.

FIG. 5 shows the interior surface of the invention with the nose/mouth filter engaged.

FIG. 6 shows a cross-sectional depiction of the air ram feature incorporated into the air intake apertures about the nose/mouth.

FIG. 7 shows the as used position of the device as described in 1.

FIG. 8 shows the as used position of the device as described in FIG. 3.

### DETAILED DESCRIPTION OF THE PREFERRED EMBODIMENTS OF THE INVENTION

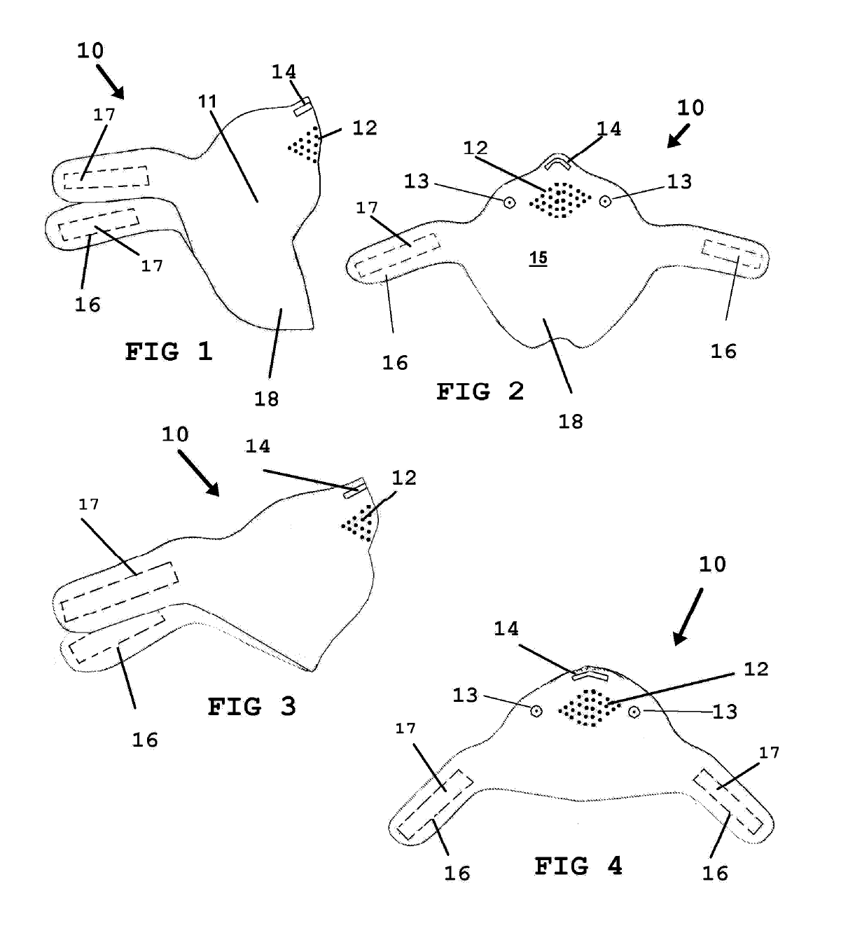

Now referring to drawings in FIGS. 1-8, wherein similar components are identified by like reference numerals, there is seen in FIG. 1 a side view of one preferred mode of the body 11 of the device 10 having a descending neck protector extension 18 hanging in front of, and spaced away from the surface of a user's neck. The extension 18 is especially preferred because it provides a means to shield the neck of the user from impacts if the device 10 is worn by a user such as a motorcycle rider, or mountain bike rider or a skier or other powersport participant.

When the device 10, in all modes, is employed by the user to an as-used position, the side straps 16 are wrapped about a users neck and engaged. The straps 16 are formed of the same material as the body 11 and are also elastic in nature and thus when engaged to each other and around the user's neck, provide a means to bias the body of the device 10 against the face of the user.

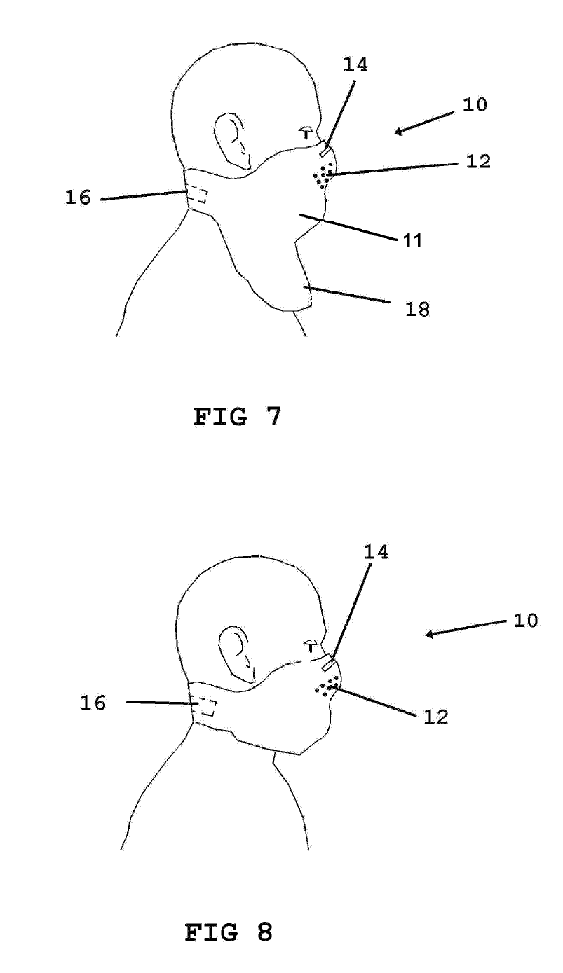

Depicted in the figure by dashed lines is one possible means of engagement such as sewn-in hook and loop fastener 17 material. Although not picture, such engagement of the side straps 16 may possibly be snap fits or other such means of engagement and should not be considered limited by the depiction in the figure. The profile of the device 10 is seen (as in FIG. 7) wherein the body 11 is configured to follow and conform the profile as generally seen in a human head and face, more specifically to follow and conform to the contours of the human nose and mouth. Employing a material with elastic qualities such as neoprene, which is initially formed to somewhat conform to the user's face by sewing or forming and heating, allows the material to slightly stretch and tend to hug the user's face when in the as-used position of FIG. 7.

Shown in FIG. 2 is a view of the interior surface 15 of the body 11 of device 10. The air apertures 12 are located generally about the nose and mouth region of the device 10 and positioned to align with the nose and mouth of the user when the device 10 is in the as-used position. One means for engagement of an air filter 20 (FIG. 6) to the invention 10 is depicted as snap fits 13. Similarly, this means of engagement should not be limited to what is depicted but could also be hook and loop fasteners 17 or other fasteners of the like such as a fabric ledge 21 (FIG. 6). Snap fits 13 are shown merely for demonstrative purposes.

The upper portion of the body 11 of the device 10 features the malleable nose piece adjusting member 14 which is engaged to the body 11 either in a pocket or by adhesive, or by other means of engagement. The nose piece 14 is of considerable malleability and resilience and tends to maintain its shape once adjusted by the user to a user's specific nose bridge. It will withstand repeated use, and provides a user-adjustable means to shape the body 11 at a portion of the body 11 where it crosses the user's nose to better conform the body 11 to hug the user's skin adjacent to and over the nose when in the as-used position. The nose piece 14 may be formed of any material which is bendable to shape and can do such repeatedly such as metal or plastic.

FIGS. 3 and 4 depict similar aspects of the invention 10 as demonstrated in FIGS. 1 and 2 but showing a second embodiment without a neck protector extension 18. The device 10 in this embodiment allows for protection from the bridge of the nose to below the chin.

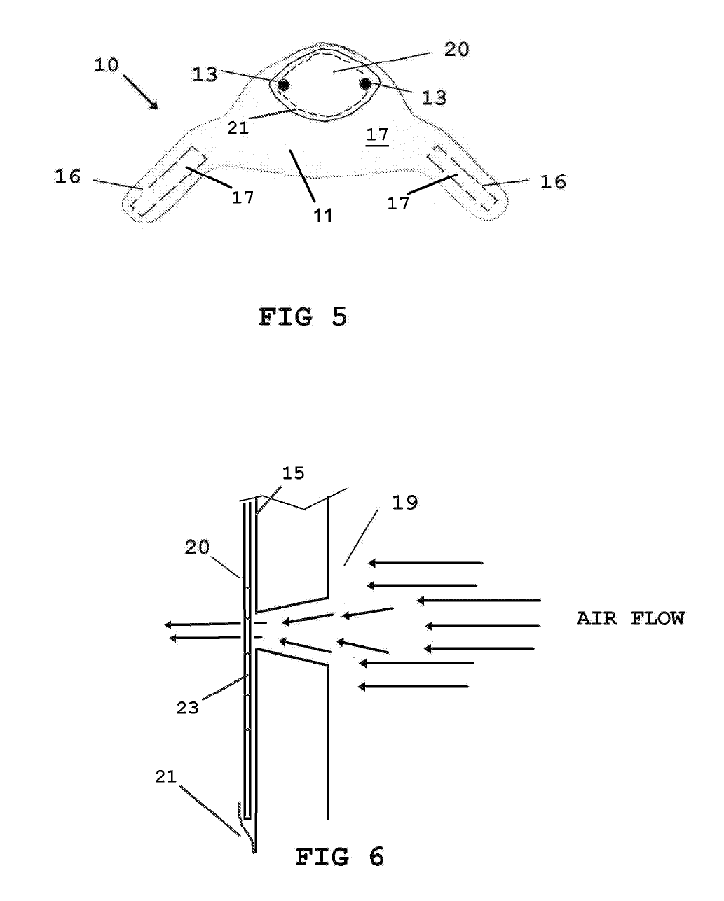

If a user decides that air filtration is needed then a filter 20 is engaged onto the interior 15 surface adjacent to the air apertures 12 as depicted in FIG. 5. Again, the engagement of the air filter 20 is depicted by snap fits 13 but should not be considered limiting. In the preferred embodiment of the device 10 the filter 20 is of bamboo and carbon-fiber construction but can take on many other modes.

Referring back to the air apertures 12 there is seen in FIG. 6 a cross-section of their communication through the device 10. Conservation of mass and momentum dictates that as air enters from the exterior surface 19 and communicates along the decreasing cross-sectional area to exit at the interior surface 15, the air velocity must increase. This creates a air ram effect whereby the larger diameter end of the aperture 12 operates as a lens to gather and actively drive air into the interior of the device 10 as a user breathes which increases the effectiveness of the filter 20 and decreases user effort.

The filter 20 which is preferred is positioned in this airstream to filter particulate other matter which may enter the apertures 12. A means to engage the filter 20 removably to the device 10 is provided by fabric ledge 21 which would cover at least two opposing side edges of the filter 20. This renders the filter 20 positioned in line with the apertures 12 and the airstream, yet removable for replacement or if the user wishes no filter 20. Filter media 23 is placed inside the filter such as activated charcoal or other filter media adapted to remove particulate.

FIGS. 7 and 8 depict the as-used position of the device 10 in all modes as described in FIGS. 1 and 3. The user fits the device 10 over their face positioning the contoured portion forming the nose and mouth over their nose and mouth and in line with the air apertures 12. Then the straps 16 are pulled snugly around the back of the head and engaged firmly about the neck using means for fastening such as the depicted hook and loop fabric 17 or other means of fastening such as snaps or buttons. Breathing by the user is as normal whether or not the filter 20 is engaged since air passage and communication to the nose and mouth of the user is aided by the accelerated airstream from the apertures 12. However the filter 20 is preferred especially when worn on a moving vehicle such as a motorcycle as it prevents particulate and liquid from reaching the user's nose and mouth. Further, it provides a chamber in front of the user's nose and mouth wherein air from multiple apertures 12 is communicated to the chamber area thereby allowing the user to breath from the single and larger chamber formed by the filter 20 instead of individual apertures 12.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A face mask apparatus configured for covering a user's face when worn in an as-used position, comprising:
a body, said body dimensioned to cover the user's nose and mouth and chin when positioned against their face in an as-used position;
means to engage said body to said as-used position with an interior surface of said body in a contact with said user's face and an exterior surface of said body opposite said interior surface;
a plurality of apertures communicating through said body in a region of said body aligned with said user's face and nose when said device is in said as-used position;
said apertures providing means to communicate air to said user when said device is in said as-used position; whereby said device worn in said as-used position, provides a shield to said face of said user who can breath through said apertures.

2. The face mask of claim 1 additionally comprising:
a filter, said filter positioned upon said interior surface and aligned with said apertures;
said filter receiving air from a plurality of said apertures and forming a chamber whereby said user can breath through their nose or mouth and inhale air from a plurality of said apertures from said chamber.

3. The face mask of claim 1 additionally comprising:
a malleable member engaged to said body at a position traversing over the top surface of a user's nose when said device is in said as-used position;
said member bendable by said user to a fit shape to conform to a diameter and angled sides of their nose; and
said member in said fit shape, providing means to maintain said body to conform with a contour of said user's nose defined by said angled sides, and in a contact with said sides of said user's nose.

4. The face mask of claim 2 additionally comprising:
a malleable member engaged to said body at a position traversing over the top surface of a user's nose when said device is in said as-used position;
said member bendable by said user to a fit shape to conform to a diameter and angled sides of their nose; and
said member in said fit shape, providing means to maintain said body to conform with a contour of said user's nose defined by said angled sides, and in a contact with said sides of said user's nose.

5. The face mask of claim 1 additionally comprising:
a shield portion, extending below a chin of said user to a distal end, said distal end spaced from, and in front of, said user's neck.

6. The face mask of claim 2 additionally comprising:
a shield portion, extending below a chin of said user to a distal end, said distal end spaced from, and in front of, said user's neck.

7. The face mask of claim 3 additionally comprising:
a shield portion, extending below a chin of said user to a distal end, said distal end spaced from, and in front of, said user's neck.

8. The face mask of claim 4 additionally comprising:
a shield portion, extending below a chin of said user to a distal end, said distal end spaced from, and in front of, said user's neck.

9. The face mask of claim 1 additionally comprising:
said apertures communicating through said body having a wider cross section at a first communication with said exterior surface than at a second cross section at said interior surface;
said cross section as said first communication providing means to accelerate said hair through said second cross section and form a force to push air into said user's nose and mouth.

10. The face mask of claim 2 additionally comprising:
said apertures communicating through said body having a wider cross section at a first communication with said exterior surface than at a second cross section at said interior surface;
said cross section as said first communication providing means to accelerate said hair through said second cross section and said filter to impart a force to push air through said chamber and into said user's nose and mouth.

11. The face mask of claim 4 additionally comprising:
said apertures communicating through said body having a wider cross section at a first communication with said exterior surface than at a second cross section at said interior surface;
said cross section as said first communication providing means to accelerate said hair through said second cross section and said filter to impart a force to push air through said chamber and into said user's nose and mouth.

12. The face mask of claim 8 additionally comprising:
said apertures communicating through said body having a wider cross section at a first communication with said exterior surface than at a second cross section at said interior surface;
said cross section as said first communication providing means to accelerate said air through said second cross section and said filter to impart a force to push air through said chamber and into said user's nose and mouth.

13. The face mask of claim 3 additionally comprising:
said apertures communicating through said body having a wider cross section at a first communication with said exterior surface than at a second cross section at said interior surface;
said cross section as said first communication providing means to accelerate said hair through said second cross section and form a force to push air into said user's nose and mouth.

14. The face mask of claim 7 additionally comprising:
said apertures communicating through said body having a wider cross section at a first communication with said exterior surface than at a second cross section at said interior surface;
said cross section as said first communication providing means to accelerate said hair through said second cross section and form a force to push air into said user's nose and mouth.
